(19) United States
(12) Patent Application Publication
(10) Pub. No.: US 2012/0086364 A1
(43) Pub. Date: Apr. 12, 2012

(54) PARTICLE BEAM COUPLING SYSTEM AND METHOD

(75) Inventor: Gary Guethlein, Livermore, CA (US)

(73) Assignee: Lawrence Livermore National Security, LLC, Livermore, CA (US)

(21) Appl. No.: 13/253,940

(22) Filed: Oct. 5, 2011

Related U.S. Application Data
(60) Provisional application No. 61/390,545, filed on Oct. 6, 2010.

(51) Int. Cl. H05H 9/00

(52) U.S. Cl. 315/505

(57) ABSTRACT

Methods and devices enable coupling of a charged particle beam to a radio frequency quadrupole (RFQ). Coupling of the charged particle beam is accomplished, at least in-part, by relying on sensitivity of the RFQ to energies of the incoming charged particle beam. A portion of a charged particle beam, which has an initial energy outside a range of RFQ's acceptance energy values, is subjected to a field that modifies its energy to fall within the range of RFQ's acceptance energy values. Once the field is removed, the charged particle beam returns to the initial energy that is outside of the RFQ' range of acceptance energy values. In another configuration, a portion of a charged particle beam, which has an initial energy within the range of RFQ's acceptance energy values, is subjected to a field that modifies its energy to fall outside the range of acceptance energy values of the RFQ.

### CROSS-REFERENCE TO RELATED APPLICATIONS

This application claims priority from U.S. Provisional Application No. 61/390,545, filed on Oct. 6, 2010, the entire contents of which is hereby incorporated by reference.

### FEDERALLY SPONSORED RESEARCH OR DEVELOPMENT

The United States Government has rights in this invention pursuant to Contract No. DE-AC52-07NA27344 between the United States Department of Energy and Lawrence Livermore National Security, LLC for the operation of Lawrence Livermore National Laboratory.

### TECHNICAL FIELD

The present application generally relates to particle accelerators, including linear particle accelerators that use dielectric wall accelerators.

### BACKGROUND

Particle accelerators are used to increase the energy of electrically-charged atomic particles, e.g., electrons, protons, or charged atomic nuclei. High energy electrically-charged atomic particles are accelerated to collide with target atoms, and the resulting products are observed with a detector. At very high energies the charged particles can break up the nuclei of the target atoms or molecules and interact with other particles. Transformations are produced that help to discern the nature and behavior of fundamental units of matter. Particle accelerators are also important tools in the effort to develop nuclear fusion devices, as well as in medical applications such as proton therapy for cancer treatment.

Proton therapy uses a beam of protons to irradiate diseased tissue, most often in the treatment of cancer. The proton beams can be utilized to more accurately localize the radiation dosage and provide better targeted penetration inside the human body when compared with other types of external beam radiotherapy. Due to their relatively large mass, protons have relatively small lateral side scatter in the tissue, which allows the proton beam to stay focused on the tumor with only low-dose side-effects to the surrounding tissue.

The radiation dose delivered by the proton beam to the tissue is at or near maximum just over the last few millimeters of the particle's range, known as the Bragg peak. Tumors closer to the surface of the body are treated using protons with lower energy. To treat tumors at greater depths, the proton accelerator must produce a beam with higher energy. By adjusting the energy of the protons during radiation treatment, the cell damage due to the proton beam is maximized within the tumor itself, while tissues that are closer to the body surface than the tumor, and tissues that are located deeper within the body than the tumor, receive reduced or negligible radiation.

Proton beam therapy systems are traditionally constructed using large accelerators that are expensive to build and hard to maintain. However, recent developments in accelerator technology are paving the way for reducing the footprint of the proton beam therapy systems that can be housed in a single treatment room. Such systems often require newly designed, or re-designed, subsystems that can successfully operate within the small footprint of the proton therapy system, reduce or eliminate health risks for patients and operators of the system, and provide enhanced functionalities and features.

### SUMMARY

Methods and devices enable coupling of a charged particle beam to a radio frequency quadrupole in particle acceleration systems and devices, including proton cancer therapy systems. Coupling of the charged particle beam is accomplished, at least in-part, by relying on of sensitivity of the radio frequency quadrupole to energies of the incoming charged particle beam. A portion of a charged particle beam, which has an initial energy beyond a range of acceptance energy values of the RFQ, is subjected to a field that modifies its energy to fall within the range of acceptance energy values of the RFQ. Once the electric field is removed, the charged particle beam returns to the initial energy value that is outside of the range of acceptance energy values of the RFQ.

One aspect of the disclosed embodiments relates to a method for coupling a charged particle beam to a radio frequency quadrupole (RFQ) that includes generating an electric field at an energy shifting component that is located at entrance of the RFQ to shift an energy of a portion of the charged particle beam from a first energy value or set of values that is outside a range of acceptance energy values of the RFQ to a second energy value or set of values that is within the range of acceptance energy values of the RFQ. This method further comprises removing the electric field to allow the charged particle beam to return to the first energy level.

Another aspect of the disclosed embodiments relates to a device for coupling a charged particle beam to a radio frequency quadrupole (RFQ) that includes an energy shifting component located at entrance of the RFQ configured to generate an electric field that shifts an energy of a portion of the charged particle beam from a first energy value or set of values that is outside a range of acceptance energy values of the RFQ to a second energy value or set of values that is within the range of acceptance energy values of the RFQ. Such a device further includes one or more voltage sources configured to supply voltages to the energy shifting component for establishing the electric field.

Another aspect of the disclosed embodiments relate to a method for coupling a charged particle beam to a radio frequency quadrupole (RFQ) that includes generating an electric field at an energy shifting component that is located at entrance of the RFQ to shift an energy of a portion of the charged particle beam from a first energy value or set of values that is within a range of acceptance energy values of the RFQ to a second energy value or set of values that is outside of the range of acceptance energy values of the RFQ. This method further comprises removing the electric field to allow the charged particle beam to return to the first energy level.

Another aspect of the disclosed embodiments relates to a device for coupling a charged particle beam to a radio frequency quadrupole (RFQ). This device includes an energy shifting component located at entrance of the RFQ configured to generate an electric field that shifts an energy of a portion of the charged particle beam from a first energy value or set of values that is within a range of acceptance energy values of the RFQ to a second energy value or set of values that is outside the range of acceptance energy values of the RFQ. The device further comprises one or more voltage sources configured to supply voltages to the energy shifting component for establishing the electric field.

### BRIEF DESCRIPTION OF THE DRAWINGS

FIG. 1 is a block diagram of a linear particle accelerator that can accommodate the disclosed embodiments.

FIGS. 2A-2C illustrate the operations of a dielectric wall accelerator that can be used in conjunction with the disclosed embodiments.

FIG. 3 illustrates an exemplary plot of a radio frequency quadrupole's acceptance energy profile.

FIG. 4 is a simplified diagram of energy shifting components and associated operations in accordance with an exemplary embodiment.

FIG. 5 illustrates a set of electrodes that can be utilized as part of energy shifting components in accordance with an exemplary embodiment.

FIG. 6 illustrates another exemplary plot of a radio frequency quadrupole's acceptance energy profile.

FIG. 7 is a simplified diagram of a voltage pulse that can be utilized to modify energy of a charged particle beam in accordance with an exemplary embodiment.

FIG. 8 is a simplified diagram of a voltage pulse, proton energy change and transmitted proton pulse in accordance with an exemplary embodiment.

FIG. 9 is another simplified diagram of a voltage pulse that can be utilized to modify energy of a charged particle beam in accordance with an exemplary embodiment.

FIG. 10 is another simplified diagram of a voltage pulse, proton energy change and transmitted proton pulse in accordance with an exemplary embodiment.

FIG. 11 is another simplified diagram of a voltage pulse that can be utilized to modify energy of a charged particle beam in accordance with an exemplary embodiment.

FIG. 12 is another simplified diagram of a voltage pulse, proton energy change and transmitted proton pulse in accordance with an exemplary embodiment.

FIG. 13 is a simplified diagram of a proton beam spill-over in a radio frequency quadrupole adjacent cycles in accordance with an exemplary embodiment.

FIG. 14 illustrates a set of exemplary operations that can be used to couple a charged particle beam to a radio frequency quadrupole in accordance with an exemplary embodiment.

FIG. 15 illustrates a simplified diagram of a device that can be used to control the operations of the components of the disclosed embodiments.

### DETAILED DESCRIPTION OF CERTAIN EMBODIMENTS

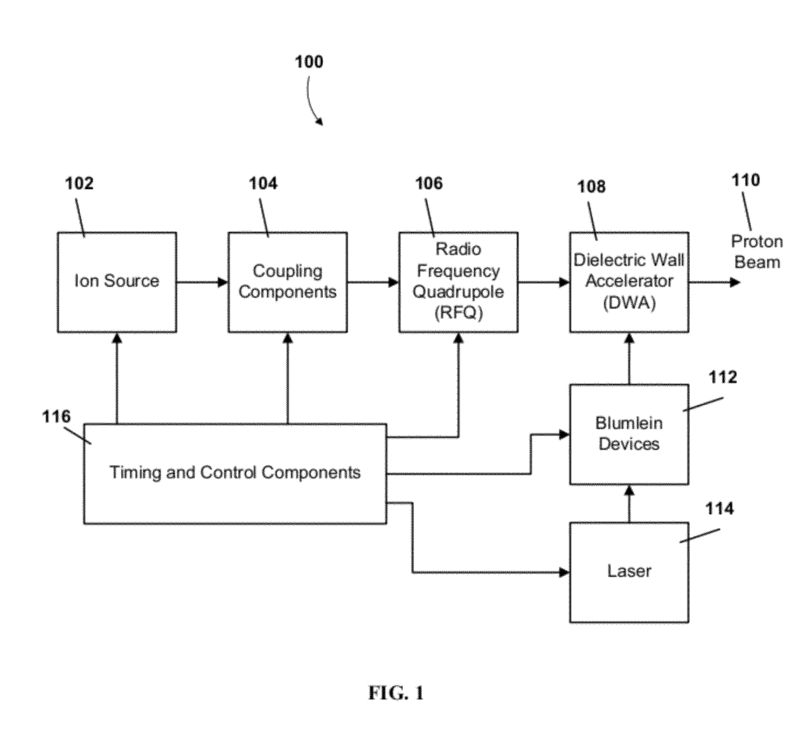

FIG. 1 illustrates a simplified diagram of a linear particle accelerator (linac) 100 that can be used to accommodate the disclosed embodiments. For simplicity, FIG. 1 only depicts some of the components of the linac 100. Therefore, it is understood that the linac 100 can include additional components that are not specifically shown in FIG. 1. An ion source 102 produces a charged particle beam that is coupled to a radio frequency quadrupole (RFQ) 106 using coupling components 104. The coupling components 104 can, for example, include components such as one or more Einzel lenses that provide a focusing/defocusing mechanism for the proton beam that is input to the RFQ 106. The coupling components 104 also include a beam energy shifting mechanism that is configured to allow selective coupling of the charged particle beam into the RFQ 106. Further details of the energy shifting mechanism are provided in the sections that follow. The RFQ 106 provides focusing, bunching and acceleration for the proton beam. One exemplary configuration of a radio frequency quadrupole includes an arrangement of four triangular-shaped vanes that form a small hole, through which the proton beam passes. The edges of the vanes at the central hole include ripples that provide acceleration and shaping of the beam. The vanes are RF excited to accelerate and shape the ion beam passing therethrough.

In the specific example in FIG. 1, the charged particle beam output by RFQ 106 is coupled to a dielectric wall accelerator (DWA) 108 that further accelerates the beam to produce an output charged particle beam, shown as an exemplary proton beam 110. FIG. 1 also shows Blumlein devices 112 and the associated laser 114 that are used to deliver voltage pulses to the DWA 108 by using the laser light to trigger switches for controlling the DWA 108. The timing and control components 116 provide the necessary timing and control signals to the various components of the linac 100 to ensure proper operation and synchronization of those components.

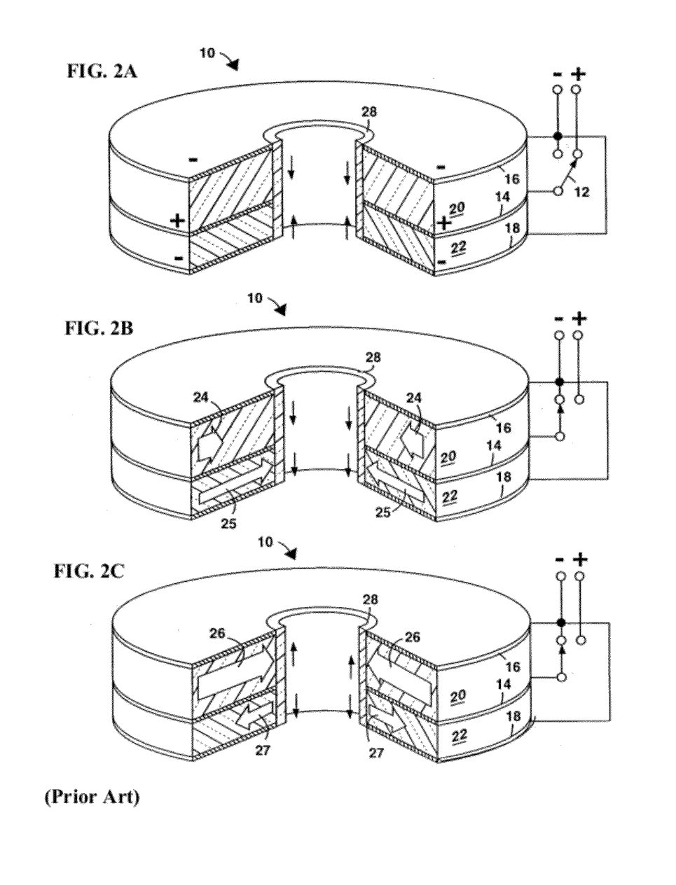

FIG. 2A, FIG. 2B and FIG. 2C provide exemplary diagrams that illustrate the operation of a single DWA cell 10 that can be utilized with the linac 100 of FIG. 1. FIGS. 2A-2C provide a time-series that is related to the state of a switch 12. As shown in FIGS. 2A-2C, a sleeve 28 fabricated from a dielectric material is molded or otherwise formed on the inner diameter of the single accelerator cell 10 to provide a dielectric wall of an acceleration tube. In some systems, the the DWA uses high gradient insulators (HGI), which is a layered insulator composed for alternating conductors and dielectrics. The HGI is capable of withstanding high voltages generated by the Blumlein devices and, therefore, provides a suitable candidate for the dielectric wall of the accelerator tube. A particle beam is introduced at one end of the accelerator tube for acceleration along the central axis. The switch 12 is connected to allow the middle conductive plate 14 to be charged by a high voltage source. A laminated dielectric 20 with a relatively high dielectric constant separates the conductive plates 14 and 16. A laminated dielectric 22 with a relatively low dielectric constant separates the conductive plates 14 and 18. In the exemplary diagram of FIGS. 2A-2C, the middle conductive plate 14 is set closer to the bottom conductive plate 18 than to the top conductive plate 16, such that the combination of the different spacing and the different dielectric constants results in the same characteristic impedance on both sides of the middle conductive plate 14. Although the characteristic impedance may be the same on both halves, the propagation velocity of signals through each half is not the same. The higher dielectric constant half with laminated dielectric 20 is much slower. This difference in relative propagation velocities is represented by a short fat arrow 24 and a long thin arrow 25 in FIG. 2B, and by a long fat arrow 26 and a reflected short thin arrow 27 in FIG. 2C. In some systems, the Blumleins comprise a linear-folded arrangement with same dielectric on both halves and different lengths from switch to gap.

In a first position of the switch 12, as shown in FIG. 2A, both halves are oppositely charged so that there is no net voltage along the inner length of the assembly. After the lines have been fully charged, the switch 12 closes across the outside of both lines at the outer diameter of the single accelerator cell, as shown in FIG. 2B. This causes an inward propagation of the voltage waves 24 and 25 which carry opposite polarity to the original charge such that a zero net voltage will be left behind in the wake of each wave. When the fast wave 25 hits the inner diameter of its line, it reflects back from the open circuit it encounters. Such reflection doubles the voltage amplitude of the wave 25 and causes the polarity of the fast line to reverse. For only an instant moment more, the voltage on the slow line at the inner diameter will still be at the original charge level and polarity. As such, after the wave 25 arrives but before the wave 24 arrives at the inner diameter, the field voltages on the inner ends of both lines are oriented in the same direction and add to one another, as shown in FIG. 2B. Such adding of fields produces an impulse field that can be used to accelerate a beam. Such an impulse field is neutralized, however, when the slow wave 24 eventually arrives at the inner diameter, and is reflected. This reflection of the slow wave 24 reverses the polarity of the slow line, as is illustrated in FIG. 2C. The time that the impulse field exists can be extended by increasing the distance that the voltage waves 24 and 25 must traverse. One way is to simply increase the outside diameter of the single accelerator cell. Another, more compact way is to replace the solid discs of the conductive plates 14, 16 and 18 with one or more spiral conductors that are connected between conductor rings at the inner and/or outer diameters.

Multiple DWA cells 10 may be stacked or otherwise arranged over a continuous dielectric wall, to accelerate the proton beamusing various acceleration methods. For example, multiple DWA cells may be stacked and configured to produce together a single voltage pulse for single-stage acceleration. In another example, multiple DWA cells may be sequentially arranged and configured for multi-stage acceleration, wherein the DWA cells independently and sequentially generate an appropriate voltage pulse. For such multi-stage DWA systems, by timing the closing of the switches (as illustrated in FIGS. 2A to 2C), the generated electric field on the dielectric wall can be made to move at any desired speed. In particular, such a movement of the electric field can be made synchronous with the proton beam pulse that is input to the DWA, thereby accelerating the proton beam in a controlled fashion that resembles a “traveling wave” that is propagating down the DWA axis. It is advantageous to make the duration of these pulses as short as possible since the DWA can withstand larger fields for pulses with narrow durations.

The disclosed embodiments facilitate the extraction of a single, narrow, proton pulse beam from a normally long-pulse train of RFQ pulses for injection into a linac system by gating the selected protons into the RFQ acceptance, while maintaining proper synchronization between the various components of the linac. To facilitate the understanding of the disclosed embodiments, consider an exemplary linac configuration in which an ion source produces a low energy proton beam (e.g., 35 keV) comprised of pulses with duration 5-20 μs, and an RFQ that operates at a frequency of 425 MHz. The low energy proton beam may be shaped with one or more Einzel lenses as part of the transport from the ion source to the RFQ. The normal output of the RFQ in such an exemplary configuration is typically a 5-10 μs train of micropulses, where each pulse is approximately 200-500 ps long and is separated from other pulses in the train by one RF period (i.e., 2.35 ns for the 425 MHz operating frequency).

Slicing a portion from a continuous beam is typically done using one or more deflection plates and physical apertures that are located between the ion source and the intended destination, which in this case would be the entrance to the RFQ. Such techniques use the physical boundary of the final aperture as a spatial acceptance to define the temporally selected beam. One problem associated with such techniques is that the transit time of the low energy beam (e.g., 35 keV beam) across the deflection plates is comparable or larger than the desired pulse width (e.g., 2.35 ns for an RFQ operating at 425 MHz). In these systems, the beam transport from the ion source to the RFQ also often passes through an Einzel lens to provide focusing. This transport mechanism produces further spread in transit times (e.g., in the order of a few nanoseconds) due to, for example, path length differences introduced by the Einzel lens. As such, even a perfect square voltage pulse that is applied to the deflection plates will result in a deflection that ramps up for approximately the proton transit time through the deflection plates. Therefore, such a configuration does not allow for maximal transmission into the RFQ during the intended pulse operation.

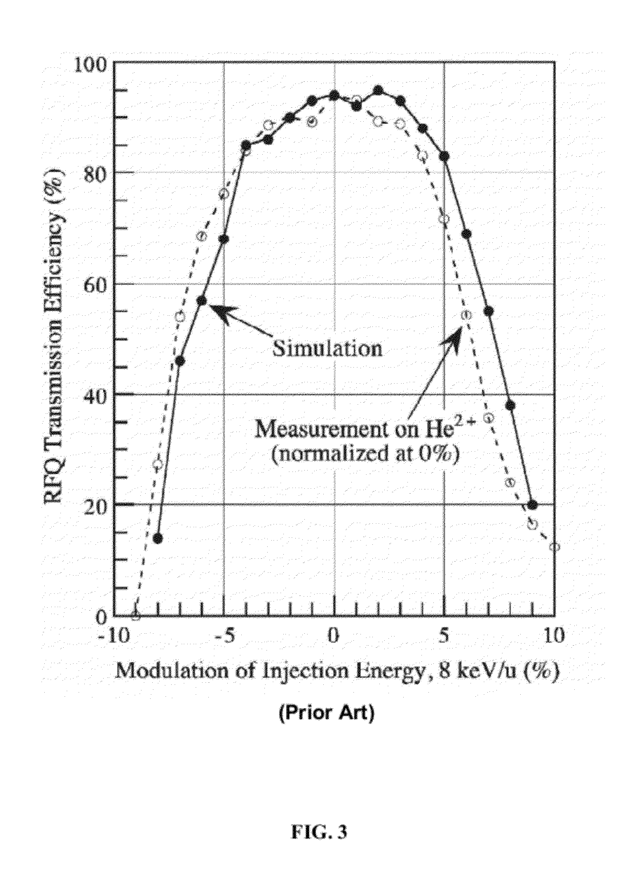

According to certain embodiments, a narrow portion of the proton beam is coupled to the RFQ by relying, in-part, on the RFQ's acceptance sensitivity to the energy of the proton beam that is incident into the RFQ. In order for the proton beam to be transported, accelerated and bunched by the RFQ, the beam energy must be within the range of RFQ acceptance energy values. FIG. 3 shows a plot of RFQ transmission efficiency as a function of proton beam energy modulation for an exemplary RFQ. FIG. 3 is merely provided to illustrate the dependency of the RFQ transmission to variations in the proton beam energy. In the exemplary plot in FIG. 3, RFQ transmission is not significantly affected for energies within the approximate range of ±5% of the peak energy, whereas modulations greater than approximately ±10% result in no transmission through the RFQ.

According to some embodiments, under normal (e.g., default) conditions, a proton beam incident upon the RFQ has an associated energy that is outside of the acceptance energy range of the RFQ. As such, under default conditions, such a proton beam, with an associated energy that is higher or lower than the range of acceptable energy values of the RFQ, fails to be accepted by, and further propagated through, the RFQ. In order to couple the proton beam into the RFQ, the energy of a narrow portion of the beam is modified (i.e., increased or decreased depending on the initial energy of the proton beam) to bring its energy within the range of energies that are accepted by the RFQ. It should be noted that the proton beam is sometimes described in the present application as having a particular energy value or set of values, or that a proton beam's energy is shifted to a value or set of values. It is understood that such references can encompass a continuous or discrete range of values associated with the proton beam energy.

In one embodiment, the energy of a narrow portion of the proton beam is modified by applying a fast voltage pulse to the beam that is propagating to the RFQ. The applied voltage serves to produce an electric field that shifts the energy of the affected protons to within the acceptance energy range of the RFQ. As a result, a narrow beam of protons (e.g., for the duration of the applied voltage pulse) is coupled to the RFQ. By utilizing the energy shifting principles of the present application, the RFQ can be filled with a short proton beam for the duration of a single RF cycle (or period). The rise and fall times of the energy-shifted proton pulse are sufficiently small to ensure that the beam injected into the RFQ substantially fills the complete RF cycle, while minimizing the spread into adjacent RF cycles. By utilizing the energy shifting methods and devices of the present application, the need for placement of a physical aperture in front of the RFQ is eliminated. Moreover, proton pulse with extremely short duration can be coupled to the RFQ.

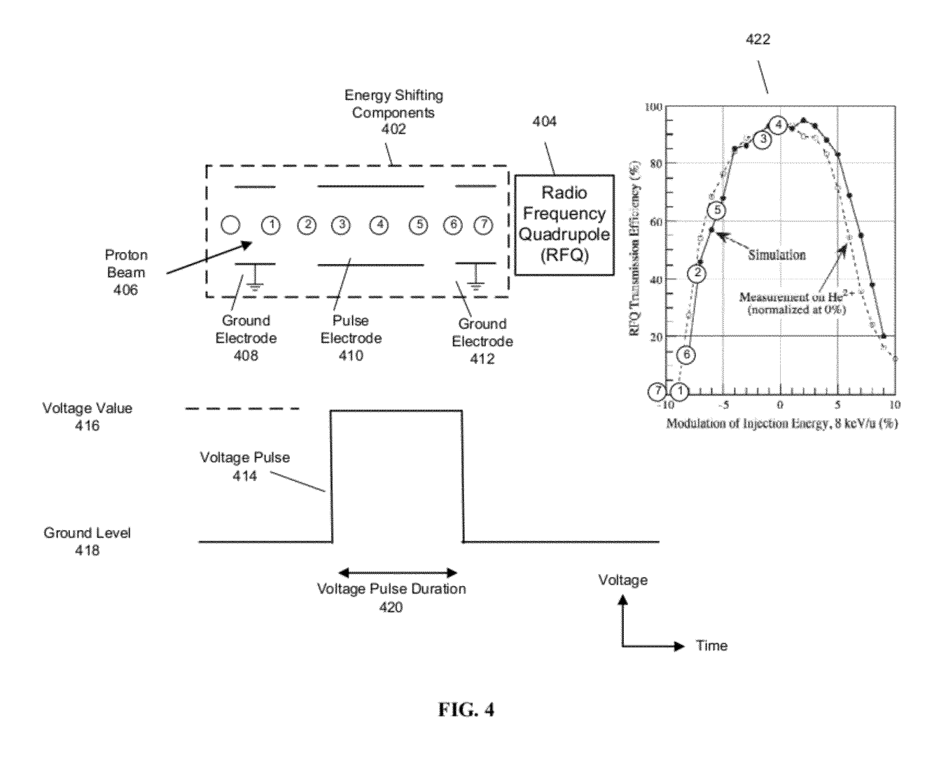

FIG. 4 is a simplified diagram that illustrates proton beam energy shifting components 402 and associated operations in accordance with an exemplary embodiment. The energy shifting components 402 are placed at the entrance of the RFQ 404. This way, the path length differences (and beam speed variations) for particles that undergo energy shifts are minimized and beam switching with rise times of less than 1 ns are made possible. The energy shifting components 402 comprise a pulse electrode 410 and one or more ground electrodes 408, 412. The energy shifting components 402 are configured to provide an unobstructed path for the proton beam 406 to the RFQ 404 entrance. The proton beam 406 has an associated energy that is outside of the acceptance energy of the RFQ 404. As such, in the absence of an energy shifting mechanism, the proton beam 406 is incident upon the RFQ 404 but fails to be accepted by the RFQ 404. When the voltage pulse 414 is applied to the pulse electrode 410, the protons that are within the electric field of the pulse electrode 410 and ground electrodes 408, 412 experience an energy shift. The voltage pulse 414 may be applied to the energy shifting components 402 using one or more voltage sources (not shown). The exemplary diagram of FIG. 4 illustrates a square voltage pulse 414 between a ground level 418 and a voltage value 416. Similarly, the energy shifting components 402 are illustrated as including a pulse electrode 410 and two ground electrodes 408 and 412. It is understood, however, that according to the disclosed embodiments, the ground electrodes can be replaced with one or more electrodes that are not at the ground level. As such, the shifting components 402 can include a pulse electrode 410 (or, more generally, one or more pulse electrodes 410) and one or more electrodes that are at a static potential. The voltage pulse 414 can still be used to establish a pulsed voltage difference between the one or more pulse electrodes 410 and the one or more electrodes at the static potential.

With proper selection of the voltage value 416, voltage pulse duration 420 and pulse electrode 410 length, and pulse electrode 410 gap, a narrow portion of the proton beam 406 can be successfully coupled to the RFQ with a particular acceptance energy characteristic. For illustration purposes, FIG. 4 shows exemplary locations of different portions of the proton beam 406, labeled as 1 through 7, on plot 422 that was previously shown in FIG. 3, after the application of the voltage pulse 414. The portions of the proton beam 406 that are labeled as 3 and 4 experience the strongest energy shift, followed by portions of the beam labeled as 5, 2 and 6. The portions of the proton beam 406 that are labeled as 1 and 7 experience the least (or no) energy shift since they are substantially outside of the electric field that is generated by voltage pulse 414.

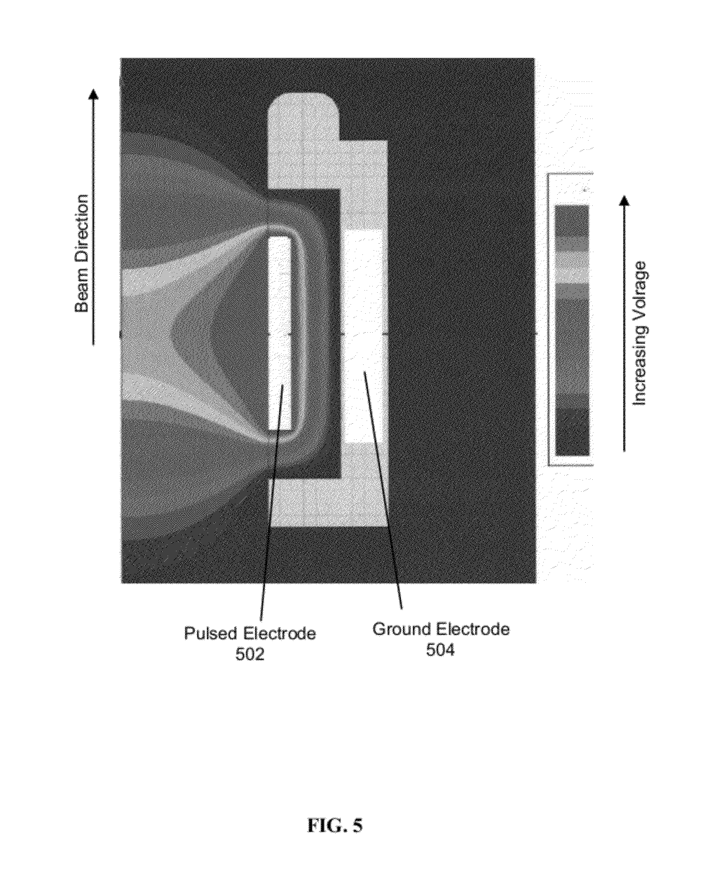

In one embodiment, a very fast transitioning voltage pulse 414 is applied to the pulse electrode 410 of length equal to the desired proton pulse length multiplied by the proton speed. In one example, the desired duration of the proton pulse is 2.35 ns and the rise time of the voltage pulse 414 is less than 200 ps. The short rise time of the voltage pulse makes the time spread due to proton motion during the voltage transition tolerable. Ideally, all protons within the pulse electrode 410 receive the same energy shift. However, edge effects of the axial electric field can result in a non-uniform energy shift, as protons in the edge field at the time of the transition receive less energy shift than those in the axial center of the electrode. The non-uniformities in the axial electric field can increase the rise time of the proton beam energy. In one example embodiment, non-uniformities of the electric field are mitigated, at least in-part, by reducing the aperture (i.e., the opening or gap in the electrode through which the proton beam propagates), thereby reducing the rise time of the proton beam pulse. FIG. 5 shows voltage contours for an electrode that is designed in accordance with an exemplary embodiment. The electrode is 8 mm long with clear aperture of 12 mm, and is rotationally symmetric about the left edge of FIG. 5. The pulsed electrode 502 is connected to a voltage source that is capable of producing a voltage pulse with a fast rise time. The ground electrode 504 is at ground potential.

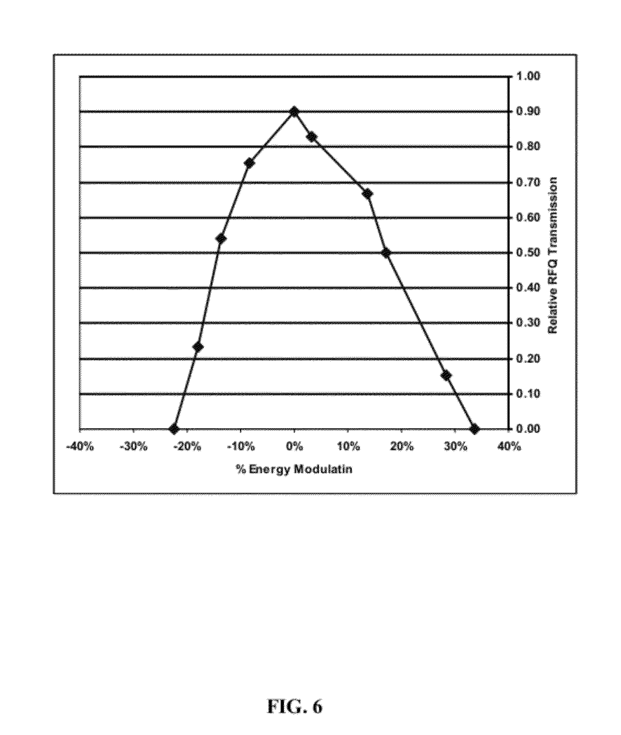

As noted earlier, the energy acceptance profile that was depicted in FIG. 3 (and reproduced in FIG. 4) corresponds to an exemplary energy acceptance profile for a particular RFQ. FIG. 6 illustrates another exemplary plot of energy modulation versus relative RFQ transmission for a different RFQ configuration. The plot of FIG. 6 exhibits an asymmetric behavior, as evident from different slopes associated with positive and negative energy modulation values. Moreover, the RFQ energy acceptance in the exemplary plot of FIG. 6 drops off slowly as a function of energy modulation (i.e., RFQ transmission reaches zero for energy modulation values beyond approximately −23% and +34%). The exemplary plot in FIG. 6, therefore, may not provide the most favorable energy acceptance profile for certain linac operations.

FIG. 3 and FIG. 6 further illustrated that a large range of RFQ acceptance energy profiles are possible, depending on the RFQ characteristics. To optimize the performance of proton energy beam switching, RFQ's with favorable energy acceptance can be designed. In general, an RFQ with a square (i.e., top-hat shape) energy acceptance profile provides for a more efficient proton gating mechanism that requires smaller energy shifts.

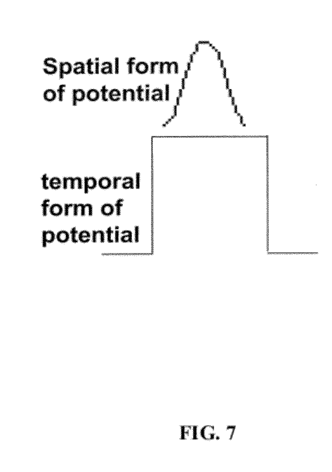

FIG. 7 schematically illustrates one type of voltage pulse that may be applied to a pulse electrode to effectuate energy shifting in accordance with an exemplary embodiment. FIG. 7 illustrates both the temporal and spatial forms of the potential. The pulse in FIG. 7 has a relatively long duration and may span several cycles of the RFQ, or could even be a simple step voltage change with rapid rise. For the long pulse waveform of FIG. 7, the proton beam energy change versus time follows the spatial form of the potential. This is because the transition of the voltage pulse is fast compared to any change in proton beam energy due to the protons motion through the potential gradient. In other words, the protons experience a non-adiabatic potential shift equal to the change in potential at the location of the proton during the voltage transition. Under a non-adiabatic process, rapidly changing conditions prevent the system from adapting its configuration due to the change. Upon exiting the electric field produced by the potential, those protons that are located closer to the RFQ entrance (e.g., the protons on the right side of potential) fall down the potential and gain kinetic energy equal to their new potential energy value due to the voltage pulse. Those protons that are further away from the RFQ entrance (e.g., on the left side of potential) need to climb up the potential, slowing down as they do. But such protons regain this energy as they leave on the electric field that is produced by the potential. Thus, such protons also acquire a net energy change equal to the potential at their location just after the voltage transition occurs.

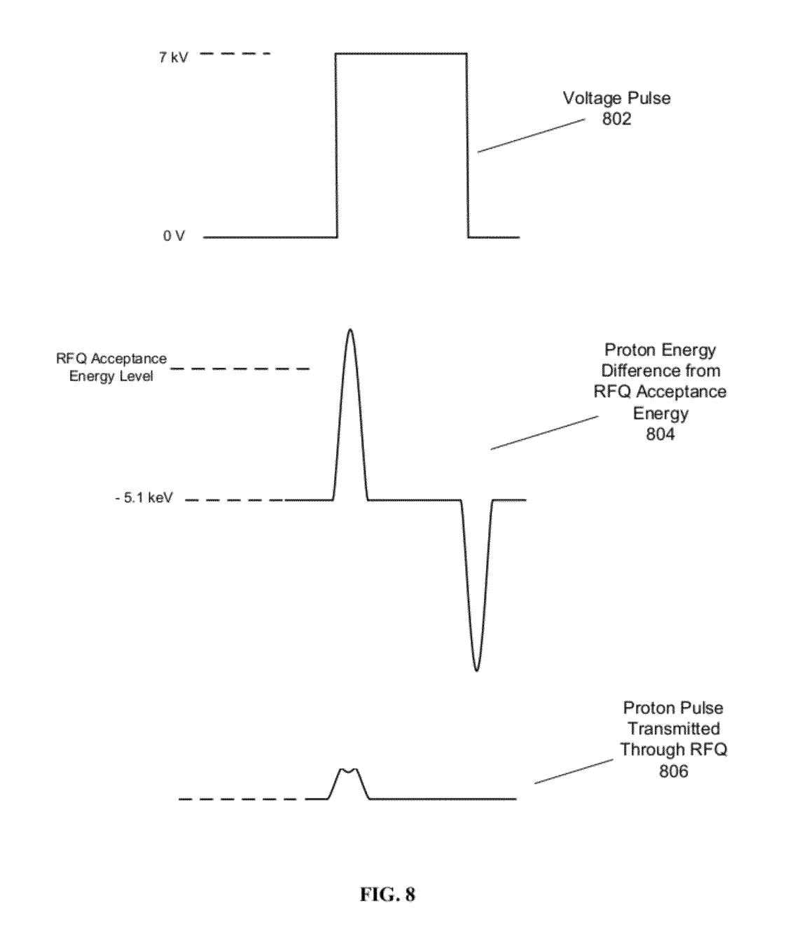

FIG. 8 illustrates an exemplary voltage pulse 802, the corresponding proton energy difference from RFQ acceptance energy 804 and the proton pulse transmitted through RFQ 806 that have been produced in accordance with an exemplary embodiment. The voltage pulse 802 is applied to the exemplary electrode of FIG. 5, and the RFQ for the exemplary scenario of FIG. 8 has an acceptance energy profile similar to that in FIG. 3. The voltage pulse 802 is a square voltage pulse with a 9 ns duration and a maximum voltage value of 7 kV. The energy of the proton beam (not shown) is 5.1 keV below the acceptance energy of the RFQ before application of the voltage pulse 802, as illustrated by the proton energy difference from RFQ acceptance energy 804. FIG. 8 also illustrates that the energy of the majority of the protons that transit the electric field during the flattop portion of the voltage pulse 802 remains unchanged, as the energy of these protons is first reduced and then increased back to the original beam energy (e.g., −5.1 keV below acceptance energy of the RFQ) after exiting the electric field. The exemplary configuration of FIG. 8 provides for the transmission of a proton pulse to the RFQ with duration of 2.35 ns.

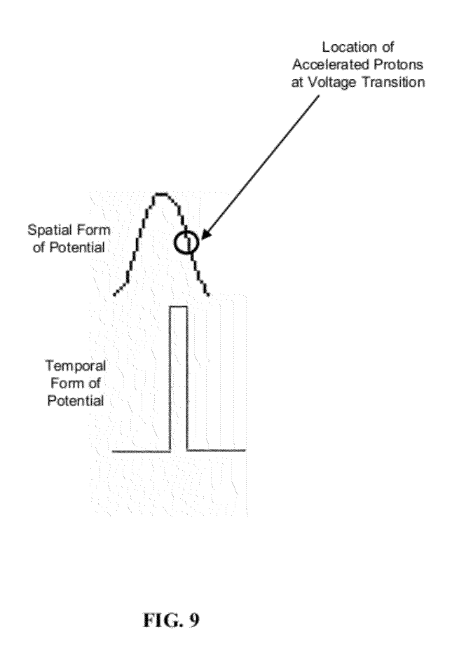

FIG. 9 schematically illustrates another type of voltage pulse that may be applied to the pulse electrode in accordance with an exemplary embodiment. FIG. 9 illustrates both the temporal and spatial forms of the potential. The spatial form of the voltage pulse of FIG. 9 is similar to the one illustrated in FIG. 7. The pulse in FIG. 9 has a relatively short duration, which may be approximately equal to, or less than one cycle of the RFQ. For the relatively short voltage pulse waveform of FIG. 9, protons on the right side of the electrode are accelerated during the on time of the voltage pulse, while the protons on the left side of the electrode are decelerated.

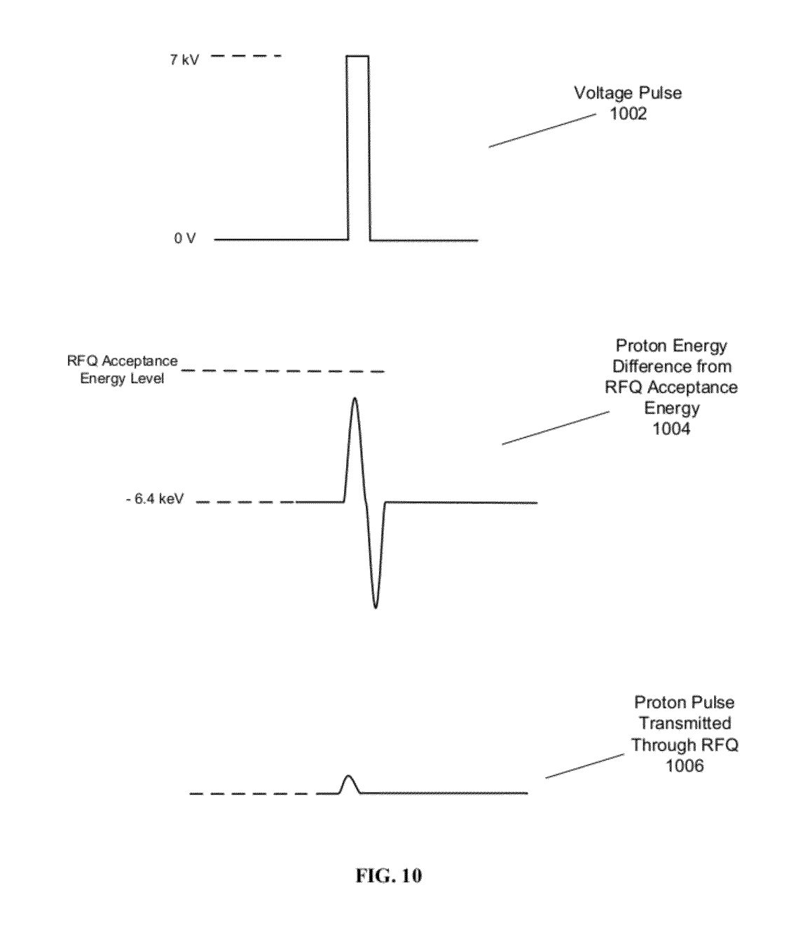

FIG. 10 illustrates another exemplary voltage pulse 1002, the corresponding proton energy difference from RFQ acceptance energy 1004 and the proton pulse transmitted through RFQ 1006 that have been produced in accordance with an exemplary embodiment. The voltage pulse 1002 is applied to the exemplary electrode of FIG. 5, and the RFQ for the exemplary scenario of FIG. 10 has an acceptance energy profile similar to that in FIG. 3. The voltage pulse 1002 is a square voltage pulse of 2.5 ns, with a maximum voltage value of 7 kV. The energy of the proton beam is 6.4 keV below the acceptance energy of the RFQ before application of the voltage pulse, as illustrated by the proton energy difference from RFQ acceptance energy 1004. As noted earlier in connection with FIG. 9, the relatively short voltage pulse 1002 of FIG. 10 accelerates or decelerates the protons depending on the position of the protons within the pulse electrode during the application of the voltage pulse. As with the exemplary configuration of FIG. 8, the configuration of FIG. 10 can generate a proton pulse with duration of 2.35 ns.

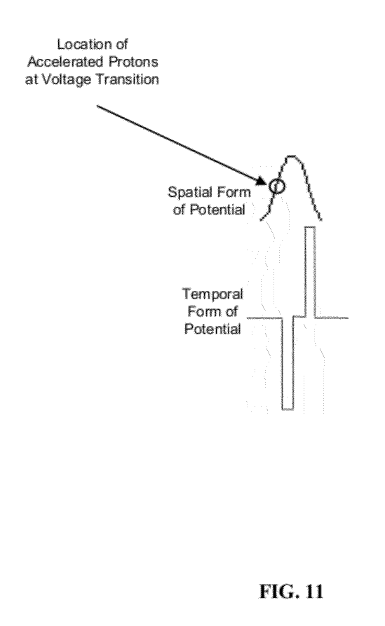

FIG. 11 schematically illustrates another type of voltage pulse that may be applied to the pulse electrode in accordance with an exemplary embodiment. FIG. 11 illustrates both the temporal and spatial forms of the potential. The spatial form of the voltage pulse of FIG. 11 is similar to those illustrated in FIGS. 7 and 9. The negative and positive pulses in FIG. 11 have a relatively short duration, which may be approximately equal to, or less than one cycle of the RFQ. For the bi-polar voltage pulse waveform of FIG. 11, protons on the right hand side of the pulse electrode during the negative pulse are decelerated, while the protons on the left hand side of the pulse electrode are accelerated. With proper pulse lengths and delays, the protons that were accelerated during the negative pulse on the left hand side arrive at the right hand side of the electrode when the positive pulse is applied and are further accelerated.

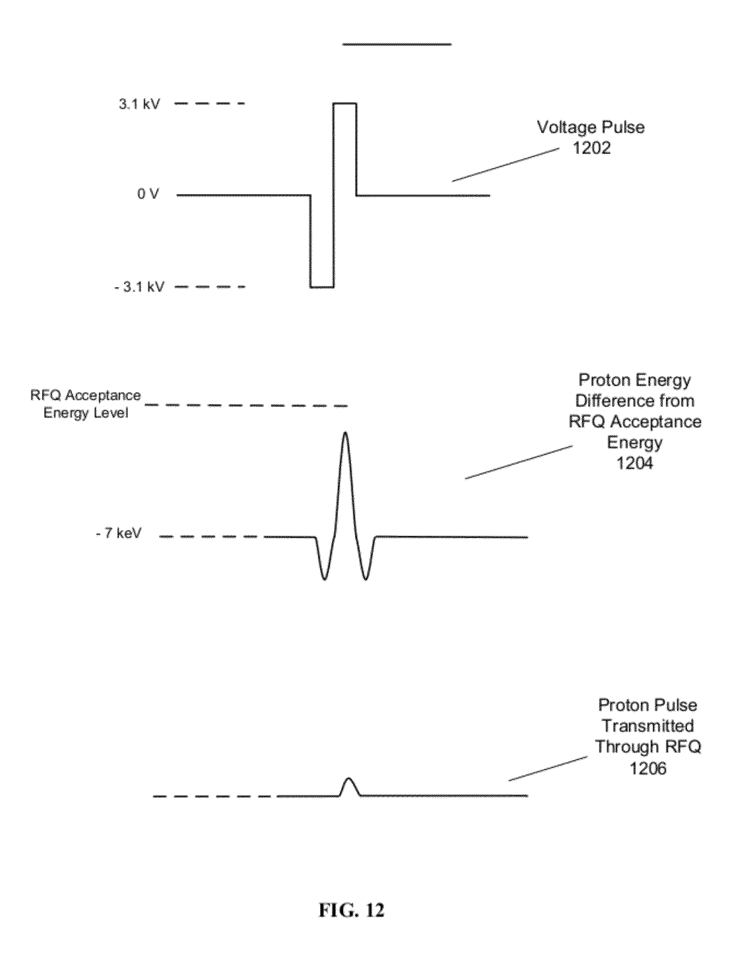

FIG. 12 illustrates an exemplary voltage pulse 1202, the corresponding proton energy difference from RFQ acceptance energy 1204 and the proton pulse transmitted through RFQ 1206 that have been produced in accordance with an exemplary embodiment. The voltage pulse 1202 is applied to the exemplary electrode of FIG. 5, and the RFQ for the exemplary scenario of FIG. 12 has an acceptance energy profile similar to that in FIG. 3. The voltage pulse 1202 is a bi-polar pulse with 3 ns pulse duration for each polarity and a voltage swing of ±3.1 kV. The energy of the proton beam is 7 keV below the acceptance energy of the RFQ before application of the voltage pulse, as illustrated by the proton energy difference from RFQ acceptance energy 1204. As with the exemplary configuration of FIGS. 8 and 10, the configuration of FIG. 12 allows a proton pulse with duration of 2.35 ns to be coupled to the RFQ.

To preserve the rise time of the voltage pulse, either coaxial cables or stripline transmission lines that are matched to the impedance of the pulse generator may be used to deliver the voltages to energy shifting components. Further, the structure of the energy shifters can be matched to the transmission line

It should be noted that FIGS. 7 to 12 illustrate only a few examples of voltage pulse shapes, voltage polarities and initial proton energy beams for a specific electrode configuration and a particular RFQ energy acceptance profile. However, it is understood that based on the disclosed principles, other voltage waveforms, polarities, electrode configurations and initial proton beam energy characteristics can be used to couple a portion of the proton beam to an RFQ with a particular acceptance energy profile.

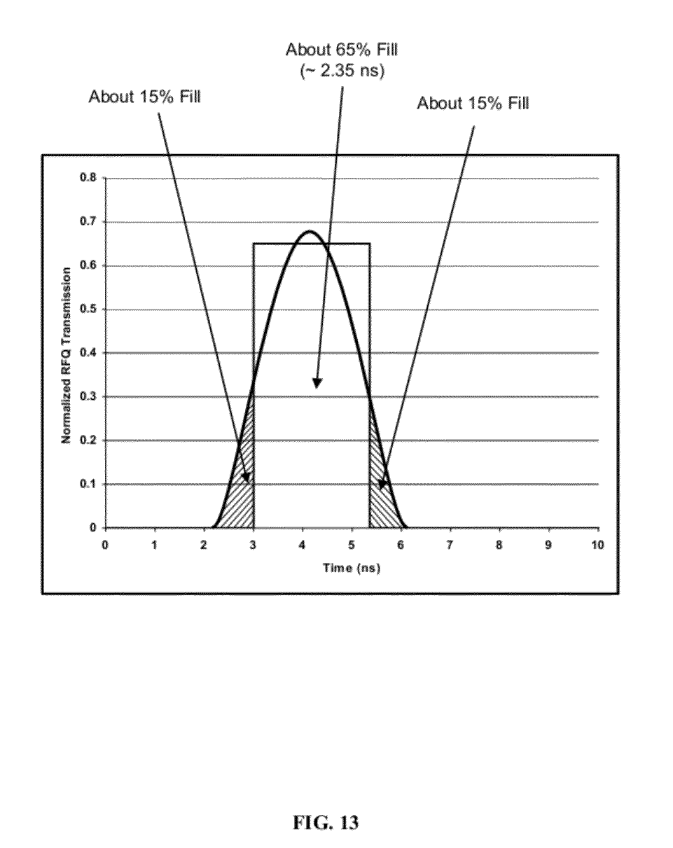

In certain configurations, a proton beam that is accepted by the RFQ may include additional protons that are coupled to adjacent RFQ cycles. This phenomenon is sometimes referred to as a “spill-over.” In some applications, the existence of pre-pulse and post-pulse protons due to the spill-over may be tolerated. Therefore, in some embodiments where, for example, the existing state of the technology and/or implementation costs, make the generation of a singular proton bunch of a particular duration infeasible, the energy shifting components and the associated parameters may be designed to allow some spill over. Moreover, regardless of the state of technology or cost considerations, in applications that can tolerate spill-overs to adjacent RFQ cycles, the amount or percentage of spill-over can be used as another adjustable parameter to facilitate proper coupling of the proton beam to the RFQ. FIG. 13 illustrates an exemplary embodiment in which 65% of the proton charge is contained within the central RFQ cycle (e.g., 2.35 ns for 265 MHz operating frequency) with about 15% spill over to each of the adjacent cycles. In other exemplary embodiments, the spill-over can span fewer or more adjacent cycles than the ones illustrated in FIG. 13.

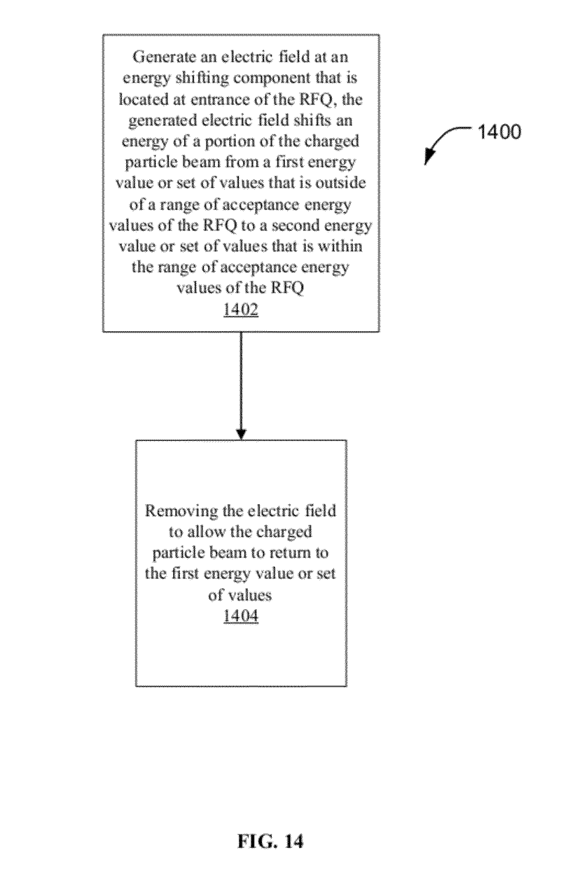

FIG. 14 illustrates a set of exemplary operations 1400 that may be carried out to couple a charged particle beam to an RFQ in accordance with an exemplary embodiment. At 1402, an electric field at an energy shifting component that is located at the entrance of the RFQ is generated. The generated electric field shifts an energy of a portion of the charged particle beam from a first energy value or set of values, which is outside a range of acceptance energy values of the RFQ, to a second energy value or set of values that is within the range of acceptance energy values of the RFQ. At 1404, the electric field is removed to allow the charged particle beam to return to the first energy value or set of values.

In some embodiments, the first energy value or set of values is less than the range of acceptance energy values of the RFQ and, therefore, the generated electric field increases the energy of a portion of the charged particle beam to values within the range of acceptance energy values of the RFQ. In other embodiments, the first energy value or set of values is greater than the range of acceptance energy values of the RFQ, and the generated electric field operates to decrease the energy of a portion of the charged particle beam to a value or set of values within the range of acceptance energy values of the RFQ.

In one exemplary embodiment, the energy shifting component that is referenced in FIG. 14 includes one or more electrodes at a static potential and one or more pulse electrodes. In this embodiment, the electric field can be generated by establishing a pulsed voltage difference, parallel to the direction of the particle beam propagation, between the one or more pulse electrodes and the one or more electrodes at the static potential. For example, the electric field can be generated by applying a voltage pulse to the one or more pulse electrodes, where the voltage pulse has a first peak value for a first duration and is zero-valued outside of the first duration. In one particular example, the first duration is larger than one period of RFQ's operating radio frequency. In another example, the first duration is less than or approximately equal to one period of RFQ's operating radio frequency.

In another exemplary embodiment, where the electric field is generated by applying a voltage pulse to the one or more pulse electrodes, the voltage pulse has a first peak value for a first duration, a second peak value that is opposite in polarity to the first peak value for a second duration, and is zero-valued outside of the first and second durations. In one particular example, the first and second durations are each less than or equal to one period of RFQ's operating radio frequency. In yet another exemplary embodiment, the static potential corresponds to ground level. In another exemplary embodiment, the coupled charged particle beam occupies two or more cycles of RFQ's operating radio frequency.

According to an exemplary embodiment, a device for coupling a charged particle beam to a radio frequency quadrupole (RFQ) is provided. The device includes an energy shifting component that is located at entrance of the RFQ and is configured to generate an electric field that shifts an energy of a portion of the charged particle beam from a first energy value or set of values that is outside a range of acceptance energy values of the RFQ to a second energy value or set of values that is within the range of acceptance energy values of the RFQ. Such a device further includes one or more voltage sources that are configured to supply voltages to the energy shifting component for establishing the electric field.

In another exemplary embodiment, under default conditions, the charged particle beam is coupled to the RFQ, and upon application of an electric field (e.g., for a short duration), the beam's energy is modified to fall outside of the RFQ's acceptance energy range. In particular, such an exemplary embodiment can be described as a method for coupling a charged particle beam to a radio frequency quadrupole that includes generating an electric field at an energy shifting component that is located at entrance of the RFQ to shift an energy of a portion of the charged particle beam from a first energy value or set of values that is within a range of acceptance energy values of the RFQ to a second energy value or set of values that is outside of the range of acceptance energy values of the RFQ. Such a method further includes removing the electric field to allow the charged particle beam to return to the first energy level.

It is understood that the various embodiments of the present disclosure may be implemented individually, or collectively, in devices comprised of various hardware and/or software modules and components. In describing the disclosed embodiments, sometimes separate components have been illustrated as being configured to carry out one or more operations. It is understood, however, that two or more of such components can be combined together and/or each component may comprise sub-components that are not depicted. Further, the operations that are described in the form of the flow chart in FIG. 14 may include additional steps that may be used to carry out the various disclosed operations.

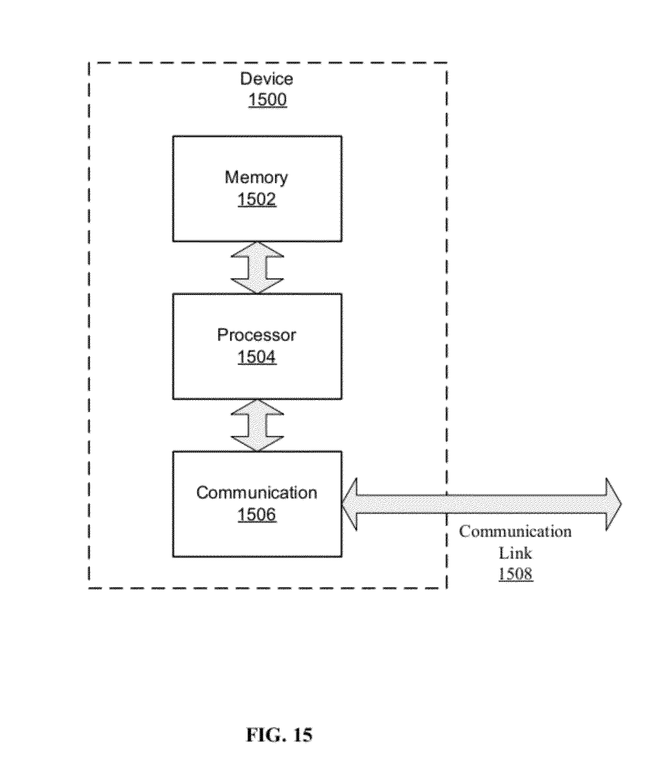

In some examples, the devices that are described in the present application can comprise a processor, a memory unit and an interface that are communicatively connected to each other. For example, FIG. 15 illustrates a block diagram of a device 1500 that can be utilized as part of the timing and control components 116 of FIG. 1, or may be communicatively connected to one or more of the components of FIG. 1. The device 1500 comprises at least one processor 1502 and/or controller, at least one memory 1504 unit that is in communication with the processor 1502, and at least one communication unit 1506 that enables the exchange of data and information, directly or indirectly, through the communication link 1508 with other entities, devices, databases and networks. The communication unit 1506 may provide wired and/or wireless communication capabilities in accordance with one or more communication protocols, and therefore it may comprise the proper transmitter/receiver antennas, circuitry and ports, as well as the encoding/decoding capabilities that may be necessary for proper transmission and/or reception of data and other information.

Various embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), Blu-ray Discs, etc. Therefore, the computer-readable media described in the present application include non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. For example, the exemplary embodiments have been described in the context of proton beams. It is, however, understood that the disclosed principals can be applied to other charged particle beams. Moreover, the generation of extremely short charged particle pulses that are carried out in accordance with certain disclosed embodiments may be used in a variety of applications that range from radiation for cancer treatment, probes for spherical nuclear material detection or plasma compression, or in acceleration experiments. The features of the embodiments described herein may be combined in all possible combinations of methods, apparatus, modules, systems, and computer program products.

What is claimed is:

1. A method for coupling a charged particle beam to a radio frequency quadrupole (RFQ), comprising:
generating an electric field at an energy shifting component that is located at entrance of the RFQ to shift an energy of a portion of the charged particle beam from a first energy value or set of values that is outside a range of acceptance energy values of the RFQ to a second energy value or set of values that is within the range of acceptance energy values of the RFQ; and
removing the electric field to allow the charged particle beam to return to the first energy level.

2. The method of claim 1, wherein
the first energy value or set of values is less than the range of acceptance energy values of the RFQ; and
the generated electric field increases the first energy value or set of values to be within the range of acceptance energy values of the RFQ.

3. The method of claim 1, wherein
the first energy value or set of values is greater than the range of acceptance energy values of the RFQ; and
the generated electric field decreases the first energy value or set of values to be within the range of acceptance energy values of the RFQ.

4. The method of claim 1, wherein
the energy shifting component comprises one or more electrodes at a static potential and one or more pulse electrodes; and
the electric field is generated by establishing a pulsed voltage difference, parallel to direction of the particle beam propagation, between the one or more pulse electrodes and the one or more electrodes at the static potential.

5. The method of claim 4, wherein
the electric field is generated by applying a voltage pulse to the one or more pulse electrodes; and
the voltage pulse has a first peak value for a first duration and is zero-valued outside of the first duration.

6. The method of claim 5, wherein the first duration is larger than one period of RFQ's operating radio frequency.

7. The method of claim 5, wherein the first duration is less than or approximately equal to one period of RFQ's operating radio frequency.

8. The method of claim 4, wherein
the electric field is generated by applying a voltage pulse to the one or more pulse electrodes; and
the voltage pulse has a first peak value for a first duration, a second peak value that is opposite in polarity to the first peak value for a second duration, and is zero-valued outside of the first and second durations.

9. The method of claim 8, wherein the first and second durations are each less than or equal to one period of RFQ's operating radio frequency.

10. The method of claim 4, wherein the static potential corresponds to ground potential.

11. The method of claim 1, wherein the coupled charged particle beam occupies two or more cycles of RFQ's operating radio frequency.

12. The method of claim 1, wherein the charged particle beam is a proton beam.

13. A device for coupling a charged particle beam to a radio frequency quadrupole (RFQ), comprising:
an energy shifting component located at entrance of the RFQ configured to generate an electric field that shifts an energy of a portion of the charged particle beam from a first energy value or set of values that is outside a range of acceptance energy values of the RFQ to a second energy value or set of values that is within the range of acceptance energy values of the RFQ; and
one or more voltage sources configured to supply voltages to the energy shifting component for establishing the electric field.

14. The device of claim 13, wherein
the first energy value or set of values is less than the range of acceptance energy values of the RFQ; and
the energy shifting component is configured to generate an electric field that increases the first energy value or set of values to be within the range of acceptance energy values of the RFQ.

15. The device of claim 13, wherein
the first energy value or set of values is greater than the range of acceptance energy values of the RFQ; and
the energy shifting component is configured to generate an electric field that decreases the first energy value or set of values to be within the range of acceptance energy values of the RFQ.

16. The device of claim 13, wherein
the energy shifting component comprises one or more electrodes at a static potential and one or more pulse electrodes; and
the energy shifting component is configured to generate the electric field by establishing a first voltage difference, parallel to direction of the particle beam propagation, between the one or more pulse electrodes and the one or more electrodes at the static potential.

17. The device of claim 16, wherein
the one or more voltage sources are configured to supply a voltage pulse to the one or more pulse electrodes; and
the voltage pulse has a first peak value for a first duration and is zero-valued outside of the first duration.

18. The device of claim 17, wherein the first duration is larger than one period of RFQ's operating radio frequency.

19. The device of claim 17, wherein the first duration is less than or approximately equal to one period of RFQ's operating radio frequency.

20. The device of claim 16, wherein
the one or more voltage sources are configured to supply a voltage pulse to the one or more pulse electrodes; and
the voltage pulse has a first peak value for a first duration, a second peak value that is opposite in polarity to the first peak value for a second duration, and is zero-valued outside of the first and second durations.

21. The device of claim 20, wherein the first and second durations are each less than or equal to one period of RFQ's operating radio frequency.

22. The device of claim 15, wherein at least one of the one or more electrodes at the static potential is a ground electrode.

23. The device of claim 13, wherein the coupled charged particle beam occupies two or more cycles of RFQ's operating radio frequency.

24. The device of claim 12, wherein the charged particle beam is a proton beam.

25. A method for coupling a charged particle beam to a radio frequency quadrupole (RFQ), comprising:
generating an electric field at an energy shifting component that is located at entrance of the RFQ to shift an energy of a portion of the charged particle beam from a first energy value or set of values that is within a range of acceptance energy values of the RFQ to a second energy value or set of values that is outside of the range of acceptance energy values of the RFQ; and
removing the electric field to allow the charged particle beam to return to the first energy level.

26. A device for coupling a charged particle beam to a radio frequency quadrupole (RFQ), comprising:
an energy shifting component located at entrance of the RFQ configured to generate an electric field that shifts an energy of a portion of the charged particle beam from a first energy value or set of values that is within a range of acceptance energy values of the RFQ to a second energy value or set of values that is outside the range of acceptance energy values of the RFQ; and
one or more voltage sources configured to supply voltages to the energy shifting component for establishing the electric field.
